(19) United States
(12) Patent Application Publication
(10) Pub. No.: US 2018/0058389 A1
(43) Pub. Date: Mar. 1, 2018

(54) EXHAUST GAS RECIRCULATION COOLER WITH DAMPING RODS

(71) Applicant: Caterpillar Inc., Peoria, IL (US)

(72) Inventor: Anthony L. DeLuca, Germantown Hills, IL (US)

(73) Assignee: Caterpillar Inc., Peoria, IL (US)

(21) Appl. No.: 15/251,387

(22) Filed: Aug. 30, 2016

(51) Int. Cl. F02M 26/29; F28F 19/00; F28F 9/00; F28F 1/00

(52) U.S. Cl. CPC F02M 26/29; F28F 19/002; F28F 2265/30; F28F 1/00; F28F 9/001

(57) ABSTRACT

An Exhaust Gas Recirculation (EGR) cooler assembly and an EGR cooler conduit assembly are provided. Heat exchange tubes in EGR cooler assemblies may vibrate and contact the EGR cooler shell, thereby leading to the tube fretting and potentially failing. The current disclosure is directed to the use of damping rods to absorb vibratory impacts and reduce or eliminate tube fretting.

### TECHNICAL FIELD

The present disclosure relates generally to an exhaust gas recirculation system and more particularly, to an exhaust gas recirculation cooler assembly.

### BACKGROUND

Combustion engines such as diesel engines, gasoline engines, and gaseous fuel-powered engines are supplied with a mixture of air and fuel for combustion within the engine that generates a mechanical power output and a flow of exhaust gases. The exhaust gases can include a complex mixture of air pollutants produced as byproducts of the combustion process. And due to increased attention on the environment, the amount of pollutants emitted to the atmosphere from an engine can be regulated depending on the type of engine, size of engine, and/or class of engine. Some engine manufacturers comply with exhaust emissions regulations by using an exhaust gas recirculation (EGR) system. EGR systems operate by recirculating a portion of the exhaust produced by the engine back to the intake of the engine to mix with fresh combustion air. The resulting mixture, when ignited, produces a lower combustion temperature and a corresponding reduced amount of regulated pollutants. Some EGR systems are equipped with an EGR cooler that serves to cool the exhaust gas before the exhaust gases return to the intake passage, thereby reducing the volume of the exhaust gas being recirculated and lowering the combustion temperature in the engine.

Known in the art is the use of EGR coolers consisting of a plurality of heat transfer or cooling tubes contained in a shell tube to cool exhaust gas. Exhaust gas flows through the cooling tubes of the EGR cooler while the coolant medium flows in the shell. Such heat transfer (or cooling) tubes are prone to vibrating and contacting the cooling tube shell under certain engine operation conditions. Such vibrations and contact can cause the shell and/or the group of heat transfer (or cooling) tubes to fret and potentially fail.

Japanese Patent No. JP2000240514A discloses use of rigid, sine curve shaped wave corrugated plates disposed between the shell and the cooling tubes, or among the cooling tubes to damp vibrations from the operation of the engine system to mitigate the problem of fatigue failure of EGR cooler components. Also, Japanese Patent No. JP2008196319A, discloses a tube support structure that is constructed so that corrugated plates or elongated metal coils formed in a coil spring shape are interposed between the shell of the EGR cooler and the cooling tubes, or between the cooling tubes, with longitudinal members of the plates or coils are oriented perpendicular to the flow of coolant through the EGR cooler assembly. The solutions disclosed in the prior art require additional complex parts that may add cost to the manufacture of EGR coolers and do not lend themselves to easy adaption of existing manufacturing or assembly lines to implement the solutions.

The foregoing background discussion is intended solely to aid the reader. It is not intended to limit the innovations described herein nor to limit or expand the prior art discussed. Thus the foregoing discussion should not be taken to indicate that any particular element of a prior system is unsuitable for use with the innovations described herein, nor is it intended to indicate any element, including solving the motivating problem, to be essential in implementing the innovations described herein. The implementations and application of the innovations described herein are defined by the appended claims.

### SUMMARY OF THE INVENTION

In one aspect, the present disclosure is directed toward an exhaust gas recirculation (EGR) cooler assembly for an engine. The EGR cooler assembly may include a first member and a second member, with the first member and the second member each having a leading surface opposite a trailing surface. The EGR cooler assembly may also include a plurality of cooling tubes disposed between the trailing surface of the first member and the leading surface of the second member. The EGR cooler assembly may additionally include a shell configured to be disposed around the plurality of cooling tubes, and at least one damping rod positioned between the shell and the plurality of cooling tubes, and the at least one damping rod having a hardness less than a material used to make the shell.

In another aspect, the present disclosure is directed to an exhaust gas recirculation (EGR) cooler conduit assembly. The EGR cooler conduit assembly may include a first member and a second member with the first member and second member each having a leading surface opposite a trailing surface. The EGR cooler conduit assembly may also include a plurality of cooling tubes disposed between the trailing surface of the first member and the leading surface of the second member. The EGR cooler conduit assembly may further include at least one damping rod having a hardness less than a material used to make the shell, and that is positioned outside the plurality of cooling tubes.

In yet another aspect, the present disclosure is directed to an exhaust gas recirculation (EGR) cooler assembly. The EGR cooler assembly may include a first member and a second member, with the first member and second member each having a leading surface opposite a trailing surface. The EGR cooler assembly may also include a plurality of cooling tubes disposed between the trailing surface of the first member and the leading surface of the second member, as well as a shell configured to be disposed around the plurality of cooling tubes. The EGR cooler assembly may include a space defined between the shell and the plurality of cooling tubes. The EGR cooler assembly may additionally include at least one damping rod having a hardness less than a material used to make the shell, and the damping rod is sized to be disposed within the space without contacting the shell or the plurality of cooling tubes. Other features and aspects of this disclosure will be apparent from the following description and the accompanying drawings.

### BRIEF DESCRIPTION OF THE DRAWINGS

FIG. 1 is a cross-sectional view of an exemplary exhaust gas recirculation cooler having an EGR cooler conduit assembly in accordance with the prior art;

FIG. 2 is an exploded view of the EGR cooler in FIG. 1 having an EGR cooler conduit assembly in accordance with the prior art.

FIG. 3 is a cross-sectional view of an EGR cooler assembly having an EGR cooler conduit assembly according to one embodiment of the present disclosure;

FIG. 4 is an exploded view of the EGR cooler assembly in FIG. 3.

FIG. 5 is a cross-sectional view of an EGR cooler assembly having an EGR cooler conduit assembly according to one embodiment of the present disclosure;

FIG. 6 is an exploded view of the EGR cooler assembly in FIG. 5.

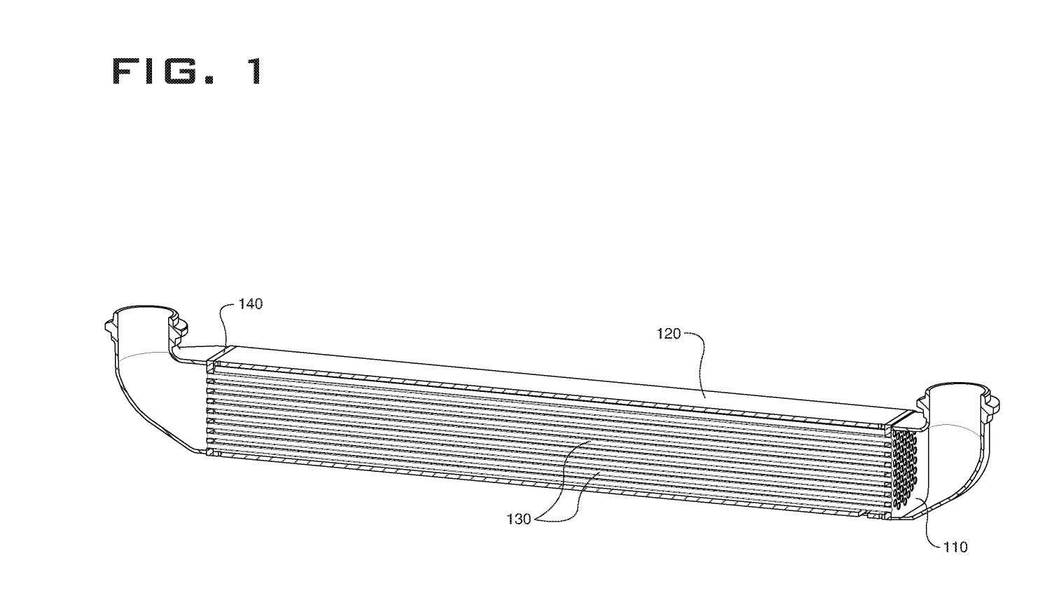

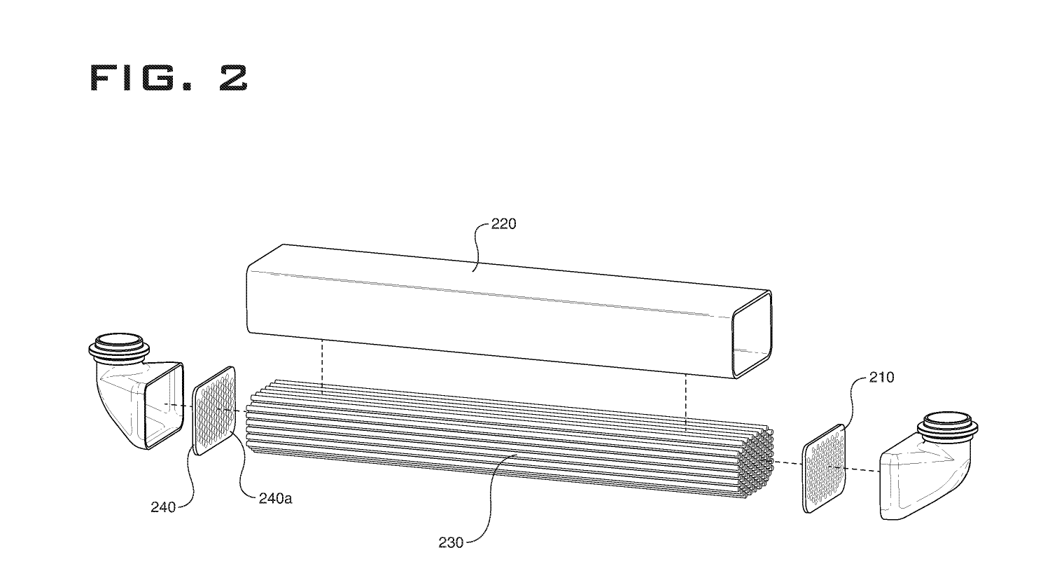

### DETAILED DESCRIPTION

Wherever possible, the same reference numbers will be used throughout the drawings to refer to the same or the like parts. FIG. 1 illustrates a cross-sectional view of an exemplary EGR cooler assembly 100 according to the prior art. FIG. 2 shows exemplary EGR cooler assembly 100 in exploded view. EGR cooler assembly 100 has a plurality of cooling tubes 130 disposed between a first member 140 and a second member 110. The first member 140 and second member 110 each have a plurality of apertures. As illustrated in FIG. 1 and FIG. 2, the plurality of cooling tubes 130, the first member 140, and the second member 110 are configured to allow exhaust gas to enter through the plurality of apertures 145 in the first member 140, between and around the plurality of cooling tubes 130, and through the plurality of apertures 115 in the second member 110. Exemplary EGR cooler assembly 100 has a shell 120 disposed around the plurality of cooling tubes 130. The shell 120 may be configured to contain the plurality of cooling tubes 130, 230 without making contact with the plurality of cooling tubes 130, 230.

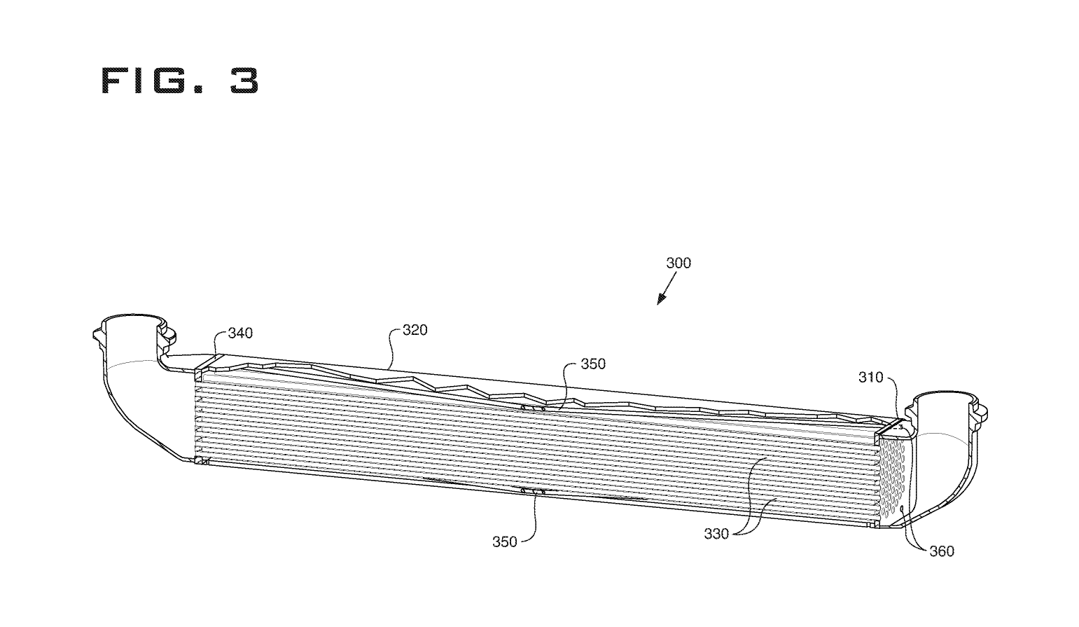

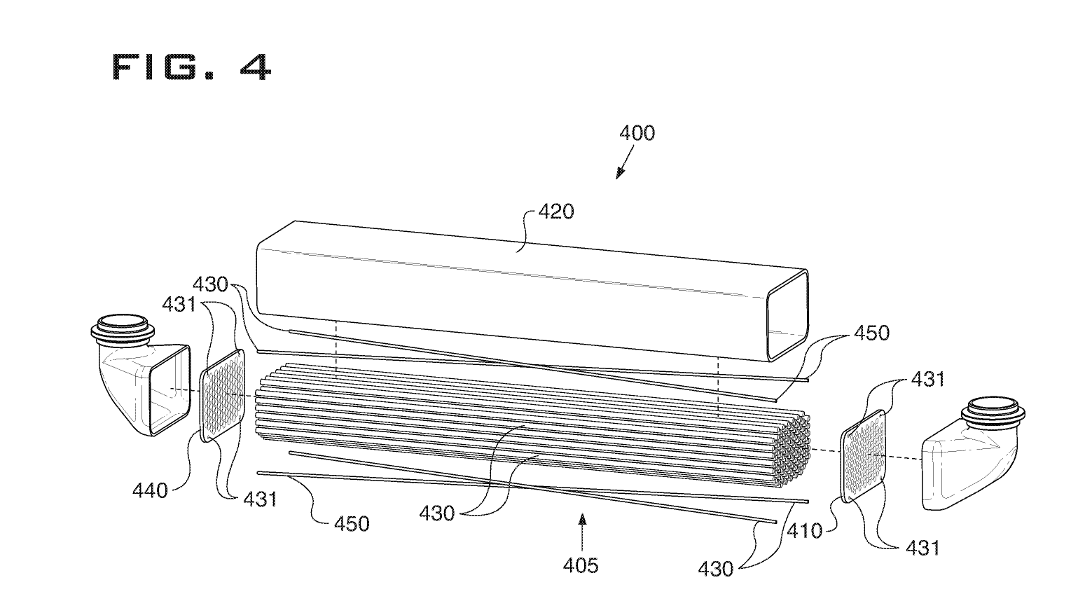

FIG. 3 depicts an EGR cooler assembly 300 according to an embodiment of the present disclosure. FIG. 4 provides an exploded view of the EGR cooler assembly 300 shown in FIG. 3 having an EGR cooler conduit assembly 405 according an embodiment of the present disclosure. The EGR cooler assembly 300 may have at least one damping rod 350, 450 disposed between the shell 320, 420 and plurality of cooling tubes 330, 430 and the damping rod(s) 350, 450 may be placed so that there is no contact between the damping rod(s) 350, 450 and either the shell 320, 420 or the plurality of cooling tubes 330, 430. As illustrated, the damping rod(s) 350 are located above and below the bundle created by the plurality of cooling tubes 330. In some embodiments of the present disclosure, the damping rod(s) 350, 450 may be disposed around the plurality of cooling tubes 330, 430 in various arrangements subject to any limitations imposed by cost, manufacturability, and space available between the shell 320, 420 and the plurality of cooling tubes 330, 430.

As illustrated, one embodiment of the EGR cooler assembly 300 has four damping rods 350 with two of the four damping rods 350 positioned atop the plurality of cooling tubes 330, 430 and two of the four damping rods 350 positioned below the plurality of cooling tubes 330. An embodiment of this disclosure, the EGR cooler assembly 300 may have damping rods 350 disposed along all four sides of the bundle created by the plurality of cooling tubes 330, 430. Likewise, in an embodiment where the plurality of cooling tubes 330, 430 form a cylindrical bundle, the damping rods 350 may be positioned across outer surface of the bundle created by the plurality of cooling tubes 130 in a number of arrangements subject to any limitations imposed by cost, manufacturability, and space available between the shell 320 and the plurality of cooling tubes 330, 430.

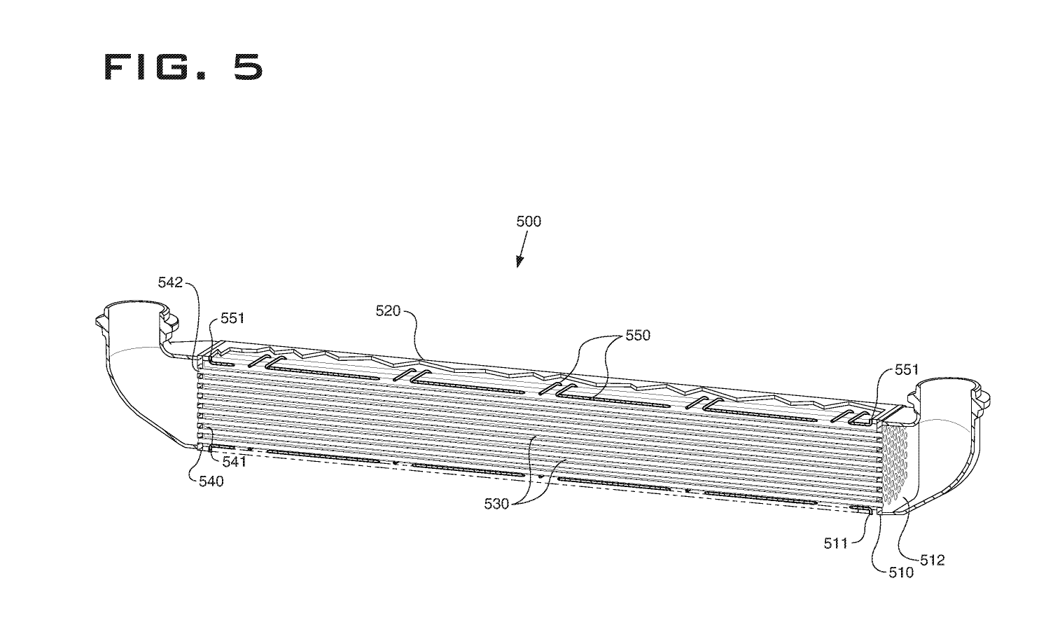

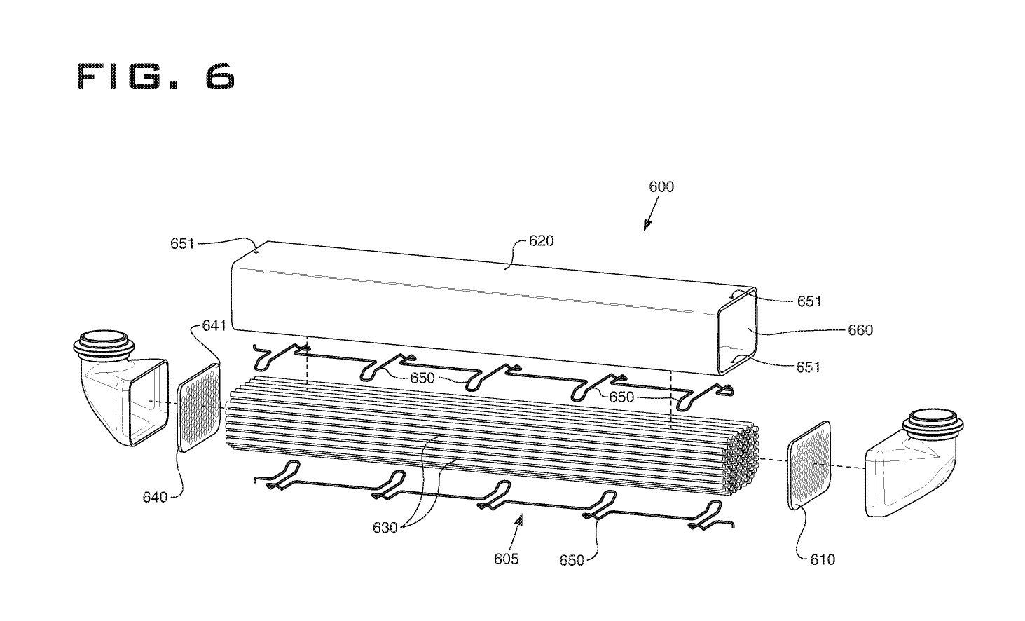

In some embodiments of EGR cooler assembly 300 and the EGR cooler conduit assembly 405 of the present disclosure, the damping rod(s) 350 may be disposed in a linear path and configured to attach to the first member 340 and a second member 310. In the embodiment illustrated in FIG. 3 and FIG. 4, the damping rod(s) 350, 450 follow a linear path. In other embodiments of the present disclosure, the damping rod(s) may be disposed in a non-linear manner. As illustrated in FIG. 5 and FIG. 6, in one such embodiment, the damping rod(s) 550, 650 may follow a serpentine path. One skilled in the art would likewise recognize various other non-linear paths that the damping rod(s) may follow, subject to limitations imposed by cost, manufacturability and space available.

In one embodiment of the present disclosure, a first end of each of the damping rod(s) 350 may be attached to a trailing surface 512 of the first member 440, 640 and a second end of each of the damping rod(s) 350 may be attached to a trailing surface 512 of the second member 410, 610. One skilled in the art would recognize that the damping rod(s) may be attached to the first member 440, 640 and the second member 410, 610 using various methods known in the art appropriate for joining the materials used to make the damping rod(s) and the first member 440, 640 and the second member 410, 610, including but not limited to brazing.

In some embodiments of the present disclosure, the plurality of damping rod(s) 450, 650 may be constructed using material that has a hardness that is less than the hardness of a material used to construct the shell 420, 620. In other embodiments of the present disclosure, the plurality of damping rod(s) 450, 650 may be constructed using material that has a hardness that is less than the hardness of a first material used to construct the shell 420, 620, and a second material used to construct the plurality of cooling tubes 430, 630.

For the purposes of this disclosure, the plurality of cooling tubes 330, 430, 530, 630 of the disclosed EGR cooler assembly 300, 500 and EGR cooler conduit assembly 405, 605 are depicted as cylindrical tubes arranged in a bundle that is substantially cuboid. One skilled in the art would recognize, however, that the heat transfer function of the EGR cooler assembly 300, 500 may be accomplished by various heat transfer elements or cooling tubes of different shapes arranged in various configurations to accomplish the function of cooling exhaust gas passing through the EGR cooler assembly 300, 500. For example, the heat transfer function of the plurality of cooling tubes 330, 530 may be accomplished using flattened tubes, tubes having an oval circumference, or thin plates. Likewise, one skilled in the art would recognize that the plurality of cooling tubes 330, 530 could be arranged in other ways. For example, the plurality of cooling tubes 330, 530 could be arranged in a cylindrical or prismatic bundle.

Further, the shell 420, 620 in the present disclosure has been illustrated in FIGS. 3-6 as being an open rectangular channel sized to be disposed around the plurality of cooling tubes 330, 530. One skilled in the art would know and recognize that the shell 420, 620 could be configured as a cylindrical tube, or any other shaped channel that allows the plurality of cooling tubes 330, 530 to be disposed therein.

Similarly, for the purposes of this disclosure, the first member 440, 640 and the second member 410, 610 are depicted as being substantially square with rounded corners. However, one skilled in the art would recognize and know that the first member 440, 640 and the second member 410,610 could be shaped as needed to coordinate with the shell 420, 620 of an exemplary EGR cooling tube. For example, the first member 440, 640 and second member 410, 610 could be circular to fit in a cylindrical shell. Likewise, the apertures 415, 445, 615, 645 in the first member 440, 460 and second member 410, 610 are depicted in the present disclosure as circular, but one skilled in the art would recognize and understand that the apertures 415, 445, 615, 645 may be slots, squares, or various other shapes that are configured to coordinate with the plurality of cooling tubes 330, 530 and that permit exhaust gas to pass through the EGR cooler conduit assembly 405, 605.

One skilled in the art would also recognize that the ends of the plurality of cooling tubes 330, 530 could be configured to be integrated into the first member 440, 640 and second member 410, 610 such that they are not separable.

### INDUSTRIAL APPLICABILITY

The disclosed EGR cooler assembly 300, 500 and EGR cooler conduit assembly 405, 605 may be implemented into any power system application where exhaust gas recirculation is utilized. The disclosed EGR cooler and EGR cooler conduit assemblies may be cost-effective, robust, and because of the compact size, may offer enhanced application opportunities, as well as the ease and low cost of manufacture. Specifically, use of one or more damping rods 450, 650 disposed between the shell 420, 620 and the plurality of cooler tubes 330, 530 as in the disclosed EGR cooler assembly 300, 500 may reduce any damage that vibratory and other forces resulting from the operation of an engine might cause to the shell 420, 620 or to the plurality of cooling tubes 330, 530. In addition, constructing the damping rod(s) using a material that has lower hardness than either a first material used to make the shell 420, 620 or a second material used to make the plurality of cooling tubes 330, 530 may allow the damping rod(s) 450, 650 to absorb any vibratory forces and preserve the shell 420, 620 and the plurality of cooling tubes 330, 530 from fretting and possible failure.

The one or more damping rods 450, 650 disposed in the space between the shell 420, 620 and the plurality of cooling tubes 330, 530 may not require any significant changes to manufacturing set ups. Those skilled in the art would be able to determine various ways of positioning the one or more damping rods 450, 650 with minimal disruption to an EGR cooler assembly 100 according to the prior art. Additionally, the cost of one or more damping rods 450, 650 made using a material that has lower hardness than either the shell 420, 620 or the plurality of cooling tubes 330, 530 should be minimal.

It will be apparent to those skilled in the art that various modifications and variations can be made to the disclosed EGR cooler assembly 300, 500 and EGR cooler conduit assembly 405, 605. Other embodiments will be apparent to those skilled in the art from consideration of the specification and practice of the disclosed EGR cooler assembly 300, 500 and EGR cooler conduit assembly 405, 605. It is intended that the specification and examples be considered as exemplary only, with a true scope being indicated by the following claims and their equivalents.

What is claimed is:

1. An EGR cooler assembly comprising:
a first member and a second member, said first member and said second member each having a leading surface opposite a trailing surface;
a plurality of cooling tubes disposed between the trailing surface of the first member and the leading surface of the second member;
a shell configured to be disposed around the plurality of cooling tubes; and
at least one damping rod positioned between the shell and the plurality of cooling tubes, and said at least one damping rod having a hardness less than a material used to make the shell or the plurality of cooling tubes.

2. The EGR cooler assembly of claim 1, wherein the at least one damping rod has a first end configured to attach to the leading surface of the first member and a second end configured to attach to the second member.

3. The EGR cooler assembly of claim 1 wherein a space is defined between the shell and the plurality of cooling tubes and the at least one damping rod is sized to be disposed within the space without contacting the shell or the plurality of cooling tubes.

4. The EGR cooler assembly of claim 1, wherein the at least one damping rod is configured to have a first end and a second end attached to the shell.

5. The EGR cooler assembly of claim 2, wherein the at least one damping rod is linear.

6. The EGR cooler assembly of claim 2, wherein the at least one damping rod is non-linear.

7. The EGR cooler assembly of claim 5, wherein the at least one damping rod is connected to an inner surface of the shell.

8. The EGR cooler assembly of claim 1 having at least two damping rods, a first damping rod disposed above the plurality of cooling tubes, and a second damping rod disposed below the plurality of cooling tubes.

9. An EGR cooler conduit assembly comprising:
a first member and a second member, each of said first member and said second member having a leading surface opposite a trailing surface;
a plurality of cooling tubes disposed between the trailing surface of the first member and the leading surface of the second member; and
at least one damping rod disposed outside the plurality of cooling tubes, and said at least one damping rod having a hardness less than a material used to make the plurality of cooling tubes.

10. The EGR cooler conduit assembly of claim 9, wherein the at least one damping rod has a first end configured to attach to the leading surface of the first member and a second end configured to attach to the second member.

11. The EGR cooler conduit assembly of claim 9 wherein the at least one damping rod is sized to be disposed without contacting the plurality of cooling tubes.

12. The EGR cooler conduit assembly of claim 10, wherein the at least one damping rod is linear.

13. The EGR cooler conduit assembly of claim 10, wherein the at least one damping rod is non-linear.

14. The EGR cooler conduit assembly of claim 13 wherein the at least one damping rod is connected to an inner surface of a shell.

15. An EGR cooler assembly comprising:
a first member and a second member, each of said first member and said second member having a leading surface opposite a trailing surface;
a plurality of cooling tubes disposed between the trailing surface of the first member and the leading surface of the second member;
a shell configured to be disposed around the plurality of cooling tubes;
a space defined between the shell and the plurality of cooling tubes; and
at least one damping rod, said at least one damping rod having a hardness less than a first material used to make the shell and a second material used to make plurality of cooling tubes, and wherein and the at least one damping rod is sized to be disposed within the space without contacting the plurality of cooling tubes.

16. The EGR cooler assembly of claim 15, wherein the at least one damping rod has a first end configured to attach to the leading surface of the first member and a second end configured to attach to the second member.

17. The EGR cooler assembly of claim 15, wherein the at least one damping rod is linear.

18. The EGR cooler assembly of claim 17, wherein the at least one damping rod is non-linear.

19. The EGR cooler assembly of claim 15 having at least two damping rods, a first damping rod disposed above the plurality of cooling tubes, and a second damping rod disposed below the plurality of cooling tubes.
